(19) United States
(12) Patent Application Publication
(10) Pub. No.: US 2006/0247116 A9
(43) Pub. Date: Nov. 2, 2006

(54) Cushioning conversion machine and method

(76) Inventors: Richard O. Ratzel, Westlake, OH (US); Joseph J. Haroing, Mentor, OH (US); Michael J. Lencoski, Claridon Township, OH (US); James A. Simmons, Painesville, OH (US); Donald J. Barnhouse, Perry, OH (US)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 11/250,695

(22) Filed: Oct. 11, 2005

Related U.S. Application Data
(63) Continuation of application No. 10/921,701, filed on Aug. 19, 2004, now Pat. No. 6,974,407.
Application No. 10/921,701 is a division of application No. 09/387,399, filed on Sep. 2, 1999, now Pat. No. 6,783,489.
Application No. 09/387,399 is a continuation of application No. 08/983,593, filed on Apr. 13, 1998, now Pat. No. 6,019,715.
Application No. 08/983,593 is a continuation of application No. PCT/US96/10899, filed on Jun. 26, 1996.
(60) Provisional application No. 60/000,496, filed on Jun. 26, 1995.

(51) Int. Cl. B31B 1/00

(52) U.S. Cl. 493/464

(57) ABSTRACT

A cushioning conversion machine and related methodology characterized by one or more features including, inter alia, a feeding/connecting assembly which enables an operator to easily vary a characteristic, for example the density, of the cushioning product; a feeding/connecting assembly wherein input and/or output wheels or rollers thereof are made at least in part of an elastomeric or other friction enhancing material, which reduces the cost and complexity of the input and output rollers; a manual reversing mechanism that is useful, for example, for clearing paper jams; a modular arrangement of a forming assembly and feeding/connecting assembly in separate units that may be positioned remotely from one another, as may be desired for more efficient utilization of floor space; a turner bar which enables alternative positioning a stock supply roll; and a volume expanding arrangement cooperative with the feeding/connecting assembly for reducing the density of the cushioning product and increasing product yield.

### RELATED APPLICATION DATA

This is a continuation of U.S. patent application Ser. No. 10/921,701 filed Aug. 19, 2004, which is a divisional of U.S. Pat. No. 6,783,489 filed on Sep. 2, 1999, which is a continuation of U.S. Pat. No. 6,019,715 filed Apr. 13, 1998, which is a continuation of International Application No. PCT/US96/10899, filed Jun. 26, 1996, which is a continuation-in-part of U.S. Provisional Patent Application No. 60/000,496 filed Jun. 26, 1995, all of which are hereby incorporated by reference.

### FIELD OF THE INVENTION

The herein described invention relates generally to a cushioning conversion machine and method for converting sheet-like stock material into a cushioning product.

### BACKGROUND OF THE INVENTION

In the process of shipping an item from one location to another, a protective packaging material is typically placed in the shipping case, or box, to fill any voids and/or to cushion the item during the shipping process. Some conventional protective packaging materials are plastic foam peanuts and plastic bubble pack. While these conventional plastic materials seem to adequately perform as cushioning products, they are not without disadvantages. Perhaps the most serious drawback of plastic bubble wrap and/or plastic foam peanuts is their effect on our environment. Quite simply, these plastic packaging materials are not biodegradable and thus they cannot avoid further multiplying our planet's already critical waste disposal problems. The non-biodegradability of these packaging materials has become increasingly important in light of many industries adopting more progressive policies in terms of environmental responsibility.

The foregoing and other disadvantages of conventional plastic packaging materials have made paper protective packaging material a very popular alterative. Paper is biodegradable, recyclable and composed of a renewable resource, making it an environmentally responsible choice for conscientious industries.

While paper in sheet form could possibly be used as a protective packaging material, it is usually preferable to convert the sheets of paper into a relatively low density pad-like cushioning dunnage product. Cushioning conversion machines in use today have included a forming device and a feeding device which coordinate to convert a continuous web of sheet-like stock material (either single-ply or multi-ply) into a three dimensional cushioning product, or pad. The forming device is used to fold, or roll, the lateral edges of the sheet-like stock material inward on itself to form a strip having a width substantially less than the width of the stock material. The feeding device advances the stock material through the forming device and it may also function as a crumpling device and a connecting (or assembling) device. The cushioning conversion machine may also include a ply separating device for separating the plies of the web before passing through the former, and usually a severing assembly, for example a cutting assembly for cutting the strip into sections of desired length.

Published European Patent Application No. 94440027.4 discloses a cushioning conversion machine wherein the feeding device comprises input and output pairs of wheels or rollers which operate at different speeds to effect, along with feeding of two plies of paper, crumpling and assembling of the paper plies to form a connected strip of dunnage. The cushioning conversion art would benefit from improvements in the machine shown in such application, and such improvements may have applicability to other cushioning conversion machines as well.

### SUMMARY OF THE INVENTION

The present invention provides an improved cushioning conversion machine and related methodology characterized by one or more features including, inter alia, a feeding/connecting assembly which enables an operator to easily vary a characteristic, for example the density, of the cushioning product; a feeding/connecting assembly wherein input and/or output wheels or rollers thereof are made at least in part of an elastomeric or other friction enhancing material, which reduces the cost and complexity of the input and output rollers; a manual reversing mechanism that is useful, for example, for clearing paper jams; a modular arrangement of a forming assembly and feeding/connecting assembly in separate units that may be positioned remotely from one another, as may be desired for more efficient utilization of floor space; a turner bar which enables alternative positioning a stock supply roll; and a volume expanding arrangement cooperative with the feeding/connecting assembly for reducing the density of the cushioning product and increasing product yield. The features of the invention may be individually or collectively used in cushioning conversion machines of various types. These and other aspects of the invention are hereinafter summarized and more fully described below.

According to one aspect of the invention, a cushioning conversion machine, for making a cushioning product by converting an essentially two-dimensional web of sheet-like stock material of at least one ply into a three-dimensional cushioning product, generally comprises a housing through which the stock material passes along a path; and a feeding/connecting assembly which advances the stock material from a source thereof along said path, crumples the stock material, and connects the crumpled stock material to produce a strip of cushioning. The feeding/connecting assembly includes upstream and downstream components disposed along the path of the stock material through the housing, at least the upstream component being driven to advance the stock material toward the downstream component at a rate faster than the sheet-like stock material can pass from the downstream component to effect crumpling of the stock material therebetween to form a strip of cushioning. Additionally, at least one of the upstream and downstream components includes opposed members between which the stock material is passed and pinched by the opposed members with a pinch pressure; and a tension control mechanism is provided for adjusting the amount of pinch pressure applied by the opposed members to the stock material. In one embodiment of the invention, the tension control mechanism includes an accessible control member outside the housing for enabling easy operator adjustment of the pinch pressure, whereby a characteristic of the strip of cushioning can be varied on demand. In another embodiment, the upstream and downstream components each include opposed members between which the stock material is passed and pinched by the opposed members with a pinch pressure; and a tension control mechanism is provided for adjusting the amount of pinch pressure applied to the stock material by the opposed members of the downstream component independently of the pinch pressure applied to the stock material by the opposed members of the upstream component, whereby a characteristic of the strip of cushioning can be varied.

According to another aspect of the invention, a cushioning conversion machine again generally comprises a housing through which the stock material passes along a path; and a feeding/connecting assembly which advances the stock material from a source thereof along the path, crumples the stock material, and connects the crumpled stock material to produce a strip of cushioning. The feeding/connecting assembly includes upstream and downstream feeding components disposed along the path of the stock material through the housing, the upstream feeding component being driven to advance the stock material toward the downstream component at a rate faster than the sheet-like stock material can pass from the downstream component to effect crumpling of the stock material therebetween to form the strip of cushioning. An adjustable speed control mechanism is provided for varying the ratio of the feeding speeds of the upstream and downstream feeding components, whereby a characteristic of the strip of cushioning can be varied. In a preferred embodiment, the adjustable speed control mechanism can include, for example, a variable speed drive device (such as a variable pitch pulley system0 for one of the upstream and downstream components, a quick change gear set, or a variable speed control for at least one of respective drive motors for the upstream and downstream components.

Preferably, a control member is provided outside the housing for enabling easy operator adjustment of the speed ratio, whereby a characteristic of the strip of cushioning can be varied on demand.

According to a further aspect of the invention, a cushioning conversion machine again generally comprises a housing through which the stock material passes along a path; and a feeding/connecting assembly which advances the stock material from a source thereof along the path, crumples the stock material, and connects the crumpled stock material to produce a strip of cushioning. The feeding/connecting assembly includes upstream and downstream components disposed along the path of the stock material through the housing, at least the upstream component being driven to advance the stock material toward the downstream component at a rate faster than the sheet-like stock material can pass from the downstream component to effect crumpling of the stock material therebetween to form a strip of cushioning. Also provided is a stretching component downstream of the downstream component that is operative to advance the strip of cushioning at a rate faster than the rate at which the stock material passes from the downstream component to effect longitudinal stretching of the strip of cushioning.

According to yet another aspect of the invention, a cushioning conversion machine again generally comprises a housing through which the stock material passes along a path; and a feeding/connecting assembly which advances the stock material from a source thereof along the path, crumples the stock material, and connects the crumpled stock material to produce a strip of cushioning. The feeding/connecting assembly includes upstream and downstream components disposed along the path of the stock material through the housing, at least the upstream component being driven to advance the stock material toward the downstream component at a rate faster than the sheet-like stock material can pass from the downstream component to effect crumpling of the stock material therebetween to form a strip of cushioning. At least one of the upstream and downstream components includes opposed members between which the stock material is passed and pinched by the opposed members with a pinch pressure; and at least one of the opposed members is at least partially made of an elastomeric material at a surface thereof engageable with the stock material.

According to a still further aspect of the invention, a cushioning conversion machine generally comprises a housing through which the stock material passes along a path; and a feeding/connecting assembly which advances the stock material from a source thereof along the path, crumples the stock material, and connects the crumpled stock material to produce a strip of cushioning. The feeding/connecting assembly includes at least one rotatable member rotatable in a first direction for engaging and advancing the stock material along the path, a feed motor for driving the one rotatable member in the first direction, and a crank coupled to the rotatable member for enabling rotation of the one rotatable member in a second direction opposite the first direction. In a preferred embodiment the crank is coupled to the rotatable member by a one-way clutch.

According to yet still another aspect of the invention, a cushioning conversion machine comprises first and second units having separate housings whereby the first and second units can be located at spaced apart locations. The first unit includes in the housing thereof a former for folding the sheet-like stock material to form flat folded stock material having a plurality of layers each joined at a longitudinally extending fold to at least one other layer. The second unit includes in the housing thereof an expanding device operative, as the flat folded stock material passes therethrough, to separate adjacent layers of the flat folded stock material from one another to form an expanded strip of stock material, and a feeding/connecting assembly which advances the stock material through the expanding device, crumples the expanded stock material passing from the expanding device, and connects the crumpled strip to produce a strip of cushioning. In a preferred embodiment, the units are used in combination with a table to form a packaging system, the table including a table top having a packaging surface. The first and second units may be both located beneath said packaging surface, and one may be supported atop the other. In alternative arrangement, the first unit may be located beneath the table top and the second unit may supported on the table top.

According to another aspect of the invention, a cushioning conversion machine generally comprises a supply assembly for supplying the sheet-like stock material; and a conversion assembly which converts the sheet-like stock material received from the supply assembly into a three-dimensional strip of cushioning. The stock supply assembly includes a support for a supply of the stock material from which the stock material can be dispensed, and a turner device which acts on the stock material to turn the stock material from a first planar orientation at its entry end to a second planar orientation at it exit end perpendicular to the first planar orientation.

According to a further aspect of the invention, a cushioning conversion machine comprises a forming assembly through which the sheet-like stock material is advanced to form the stock material into a three-dimensional shape and a feeding/connecting assembly that advances and crumples the formed strip, and connects the crumpled formed strip to produce a strip of cushioning. The forming assembly includes a forming member and a converging chute cooperative with the forming member to cause inward rolling of the edges of the stock material to form lateral pillow-like portions of a formed strip, and the feeding/connecting assembly includes upstream and downstream components disposed along the path of the stock material through the machine, at least the upstream component being driven to advance the stock material toward the downstream component at a rate faster than the sheet-like stock material can pass from the downstream component to effect crumpling of the stock material therebetween to form a strip of cushioning.

According to yet another aspect of the invention, a cushioning conversion machine comprises a feeding/connecting assembly which advances the stock material from a source thereof along a path through the machine, crumples the stock material, and connects the crumpled stock material to produce a strip of cushioning. The feeding/connecting assembly includes upstream and downstream feeding components disposed along the path of the stock material through the housing, the upstream feeding component being driven continuously to advance continuously the stock material toward the downstream feeding component during a cushioning formation operation, and the downstream feeding component being driven intermittently to advance periodically the stock material. Accordingly, when the downstream feeding component is not driven the stock material will be caused to crumple longitudinally between the upstream and downstream feeding components, and when driven the longitudinally crumpled stock material will be advanced by the downstream feeding component toward an exit end of the machine.

According to a still further aspect of the invention, a method for making a cushioning product, by converting an essentially two-dimensional web of sheet-like stock material of at least one ply into a three-dimensional cushioning product, generally includes the steps of supplying the stock material, and using an upstream component of a feeding/connecting assembly to advance the stock material toward a downstream component of the feeding/connecting assembly at a rate faster than the stock material can pass from the downstream component to effect crumpling of the stock material therebetween to form the strip of cushioning, the upstream and downstream components including opposed members between which the stock material is passed and pinched by the opposed members with a pinch pressure. In one embodiment, the method includes the step of adjusting the amount of pinch pressure applied by the opposed members of the downstream component independently of the pinch pressure applied to the stock material by the opposed members of the upstream component to the stock material, whereby a characteristic of the strip of cushioning can be varied. In another embodiment, method includes the step of varying the ratio of the feeding speeds of the upstream and downstream feeding components, whereby a characteristic of the strip of cushioning can be varied.

The foregoing and other features of the invention are hereinafter fully described and particularly pointed out in the claims, the following description and the annexed drawings setting forth in detail certain illustrative embodiments of the invention, these being indicative, however, of but a few of the various ways in which the principles of the invention may be employed.

### BRIEF DESCRIPTION OF THE DRAWINGS

FIG. 1 is a schematic side view of a cushioning conversion machine according to the present invention, with parts removed and broken away to permit viewing of internal machine components.

FIG. 2 is a schematic plan view of the cushioning conversion machine of FIG. 1.

FIG. 3 is a sectional view of a feeding/crumpling assembly employed in the conversion machine.

FIG. 3A is a fragmentary view showing a gear in the drive train.

FIG. 4A is an edge view of a top input roller.

FIG. 4B is a side view of the top input roller of FIG. 4A.

FIG. 4C is an edge view of a bottom input roller.

FIG. 4D is a side view of the bottom input roller of FIG. 4C.

FIG. 4E is an edge view of a top output roller.

FIG. 4F is a side view of the top output roller of FIG. 4E.

FIG. 4G is an edge view of a bottom output roller.

FIG. 4H is a side view of the bottom output roller of FIG. 4G.

FIG. 5A is schematic side view of a cushioning conversion machine including a different forming assembly.

FIG. 5B is a schematic plan view of the cushioning conversion machine of FIG. 5.

FIG. 6A is a schematic plan view of the Figures/crumpling assembly of FIG. 3.

FIG. 6B is a side view of the feeding/crumpling assembly of FIG. 3, looking from the line 6B-6B of FIG. 6A.

FIG. 6C is a cross-sectional view of the feeding/crumpling assembly of FIG. 3, looking from the line 6C-6C of FIG. 6A.

FIG. 7 is a side view of a variable pitch pulley system drive.

FIG. 8 is a side view of the feeding/crumpling assembly of FIG. 3, modified to include a tension adjust knob.

FIG. 9 is a front end view of the feeding/crumpling assembly of FIG. 8.

FIG. 10 is a schematic view illustrating a feeding motor reverse assembly.

FIG. 11A is a schematic plan view of a modular converting unit, with parts removed and broken away to permit viewing of internal machine components.

FIG. 11B is an end view of an expanding device employed in the modular converting unit of FIG. 11A, the device being shown with flat-folded stock material expanded thereby.

FIG. 11C is a side view of the expanding device of FIG. 11B, without the stock material.

FIG. 12 is schematic plan view of a modular forming unit useful with the modular converting unit of FIG. 11, with parts removed and broken away to permit viewing of internal machine components.

FIG. 13 is a side elevational view of a packaging system comprising a packaging table and the modular forming and converting units of FIGS. 11 and 12, with parts removed and broken away to permit viewing of internal machine components.

FIG. 14 is a side elevational view of another packaging system comprising another arrangement of a packaging table and the modular converting and forming units of FIGS. 11 and 12, with parts removed and broken away to permit viewing of internal machine components.

FIG. 15 is a side elevational view of still another packaging system comprising another arrangement of a packaging table and the modular converting and forming units of FIGS. 11 and 12, with parts removed and broken away to permit viewing of internal machine components.

FIG. 16 is a side elevational view of a further packaging system comprising another arrangement of a packaging table, the modular forming unit of FIG. 12, and another form of modular converting unit, with parts removed and broken away to permit viewing of internal machine components.

FIG. 17 is a partial plan view of the upstream end of a cushion conversion machine showing a turner bar for use with an upright supply roll.

FIG. 18 is a side elevational view of the upstream end of the cushioning conversion machine of FIG. 17 showing further details of the turner bar.

FIG. 19A is a plan view of a modified feeding/connecting assembly including an additional set of feeding rollers for stretching the strip of cushioning passing from the upstream set of feeding rollers.

FIG. 19B is a side elevational view of the modified feeding/connecting assembly of FIG. 19A looking from the line 19B-19B.

FIG. 19C is cross-sectional view of the modified feeding, crumpling connecting assembly of FIG. 19A taken along the line 19C-19C.

FIG. 20 is a side elevational view of another modified form of feeding/connecting assembly.

FIG. 21 is an end elevational view of the modified feeding/connecting assembly of FIG. 20.

### DETAILED DESCRIPTION

The references herein to downstream and upstream are made in relation to the movement direction of the stock material through the machine. It will also be appreciated that references to top and bottom, upper and lower, etc. are made in relation to an illustrated orientation of the machine to describe positional relationships between components of the machine and not by way of limitation, unless so indicated. The present invention also embodies the various combinations of any one feature of the invention with one or more other features of the invention, even though shown in separate embodiments.

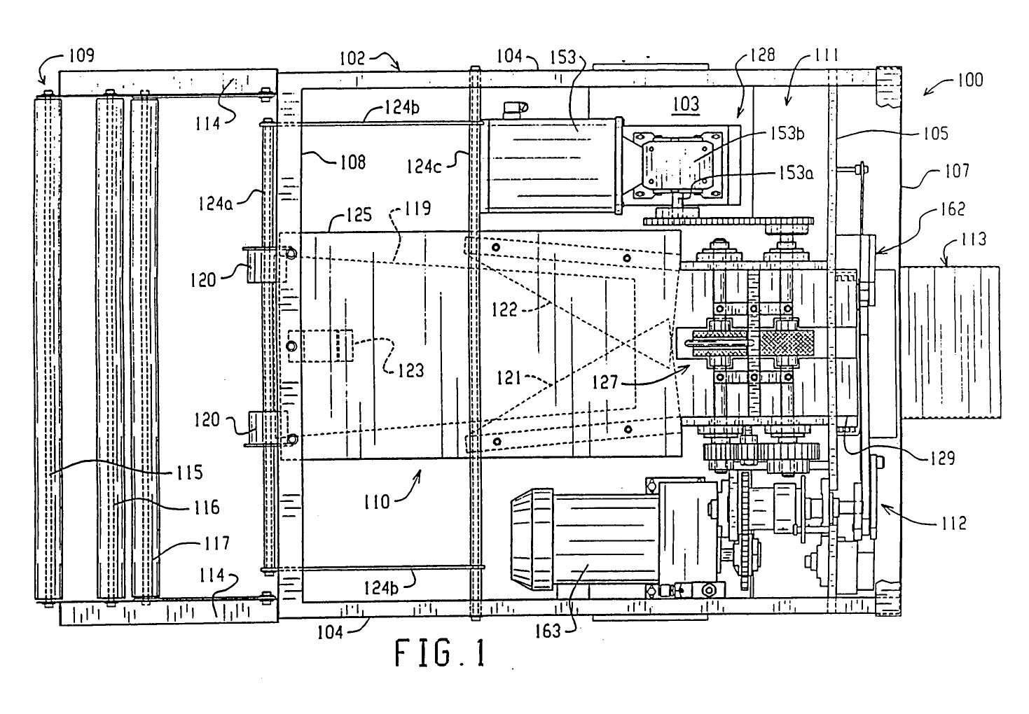

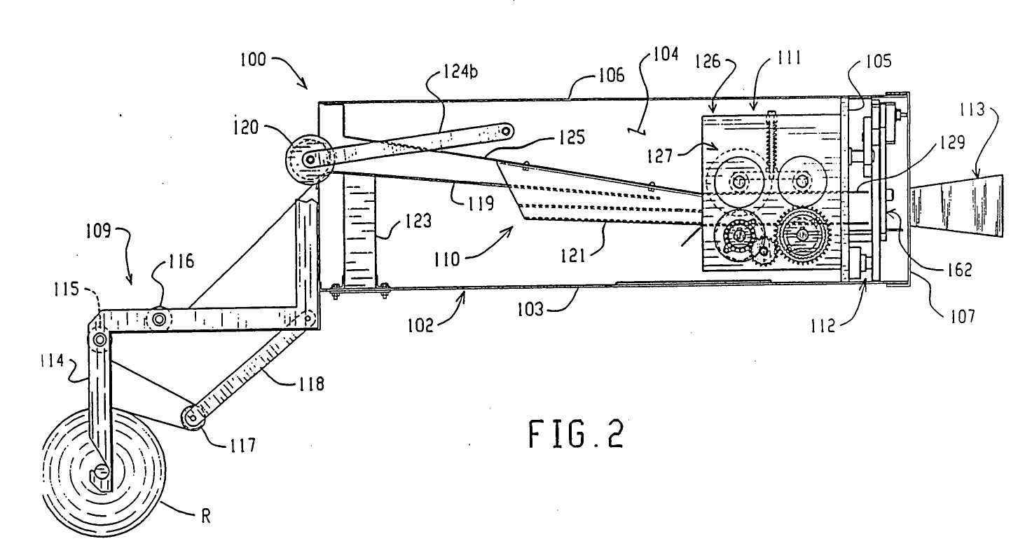

Referring now to the drawings in detail, and initially to FIGS. 1 and 2, an exemplary cushioning conversion machine 100 is illustrated. The machine 100 has at its rear end (to the left in FIG. 1), a holder 101 for a supply, such as a roll R, or rolls, of sheet-like stock material. The stock material preferably consists of plural, for example two, plies or layers of biodegradable and recyclable sheet-like stock material such as 30 to 50 pound Kraft paper rolled onto a hollow cylindrical tube. The illustrated exemplary machine 100 converts the stock material into a continuous strip of cushioning having, for example, lateral accordion-like portions separated by a thin central band. This strip is connected (assembled) generally along its central band to form a cushioned strip of cushioning product that may be severed, e.g. cut, into sections, or pads, of a desired length.

The machine 100 includes a housing 102 having a base plate or wall 103, side plates or walls 104, and an end plate or wall 105 which collectively form a frame structure. The base wall 103 is generally planar and rectangular in shape. The housing 102 also includes a top cover 106, which together with the base, side and end walls, form an enclosure.

The base and side walls 103 and 104 have at the upstream end of the housing inturned edge portions forming a rectangular border around a centrally located, and relatively large, rectangular stock inlet opening 107. This border may be viewed as an end plate or wall extending perpendicularly from the upstream edge of the base wall 103. It should be noted that the terms “upstream” and “downstream” are herein used in relation to the direction of flow of the stock material through the machine 100. The end plate 105 extends perpendicularly from a location near, but inward from, the downstream end of the base wall 103. The end plate 105 is generally rectangular and planar and includes a dunnage outlet opening.

The housing (or frame) 102 also includes a front cover or plate 108 which extends perpendicularly from the downstream edge of the base wall 103. Thus, the end plate 105 and front plate 108 bound upstream and downstream ends of a box-like extended portion of the downstream end of the housing 102. The front plate 108 may be a door-like structure which may be selectively opened to access cutting assembly components of the cushioning conversion machine 100.

The machine 100 further includes a stock supply assembly 109, a forming assembly 110, a feeding/connecting assembly 111 powered by a gear drive motor, for example an electric motor 111a, a severing/aligning assembly 112 powered by a cutter motor, for example an electric motor 112a (FIG. 2), and a post-severing or post-cutting guide, and preferably constraining, assembly 113. The stock supply assembly 109, including a stock roll axle 114 supported by the holder 101 and guide rollers 115 and 116, is mounted to an upstream side of the housing 102 or more particularly the upstream end plate or wall 105.

The roles the aforesaid assemblies, and components thereof, play in the formation of such a cushioning product are explained below in detail. In regard to the various functions performed by the noted assemblies and components thereof (as well as any other assemblies and components herein described), the terms (including a reference to a “means”) used to identify the herein-described assemblies and devices are intended to correspond, unless otherwise indicated, to any assembly/device which performs the specified function of such an assembly/device that is functionally equivalent even though not structurally equivalent to the disclosed structure which performs the function in the illustrated exemplary embodiment of the invention.

The stock supply assembly 109 in the illustrated machine 100 performs the function of supplying the paper stock material that is to be converted into dunnage. The paper is unwound from the supply roll and passes under the dancer roller 117. The dancer roller pivots about a pin 118 as the tension on the paper is increased or decreased. The function of the dancer roller 117 is to smooth out the starts and stops of the feeding/connecting mechanism 111 and to help maintain a greater uniformity of tension on the paper.

The paper then travels over and under two guide rollers 115 and 116. The function of these rollers is to help guide the paper and maintain uniformity of tension on the paper. The rollers and paper roll axle 114 are supported by two roll brackets 120 and 121 (of the holder 101), which are fixedly attached to the main frame of the machine 100.

The paper may be of two plies that are intermittently glued together with small drops of glue up the center of the paper plies and the glue drops being spaced approximately 1 foot apart. The glue drops may be used to facilitate loading, prevent bagging of the plies, prevent migration of the plies from side to side, and to promote pulling both plies uniformly through the feeding/connecting assembly 111.

The forming assembly 110 is located downstream of the stock supply assembly 109 interiorly of the housing and functions to form the stock material into a continuous three-dimensional strip of dunnage having portions of the stock material overlapped along the central region of the strip.

The forming assembly 110 consists of a folder plate 122, folder rollers 123 and 124, and two side chute plates 125 and 126. The folding plate 122 has a rounded upstream or entry end over which the central region of the paper passes.

The upstream end of the folder plate 122 is narrower than (preferably approximately about one-third) the width of the paper such that lateral edge portions of the paper overhang the sides of the folder plate 122. From its upstream end, the folder plate 122 tapers to its narrower downstream end.

The folder rollers 123 and 124, mounted on an axle extending between the ends of pivot arms, further encourage the paper to fold down on either side of the folder plate 122. The folder rollers 123 and 124 preferably have annular flanges at the outer sides thereof which overhang respective side edges of the folder plate 122 for urging downwardly the lateral edge portions of the outer layer overhanging the folder plate 122. Further downward urging or folding of the lateral edge portions is effected by edge guides 127 and 128 extending generally perpendicular to the folder plate 122 and spaced from respective side edges of the folder surface at a location downstream of the upstream end portion of the folder plate and upstream of the side walls of the folding channel.

As the paper progresses toward the feeding/connecting assembly 111, the edges of the side chute plates 125 and 126 begin to guide the paper inwards. The bottom edge of one side of the chute plates is closer to the folder plate 111 than the other. Consequently, this causes the edge of the paper on one side to fold on top of the edge of the paper on the other side. When the paper leaves the folding assembly 110, it is a loosely folded pad that is approximately the width of the downstream end of the converging channel.

The feeding/connecting assembly 111 is located downstream of the forming assembly 110 and is mounted on an upstream side of the downstream end plate 105. On the opposite or downstream side of the downstream end plate 105, the severing assembly 112 is mounted. The motors are mounted on the base wall 103 which may be provided with a transverse mounting plate 129 which forms part of the base wall or plate 103. The motors are disposed on opposite sides of the forming assembly 110. The post-severing guide assembly 113 is located downstream of the severing assembly 112 and it is mounted on the front plate 108.

The feeding/connecting assembly 111 in the illustrated machine 100 performs two primary functions. The feeding/connecting assembly 111 connects the overlapped portions of the stock material to help form and maintain the three-dimensional shape of the strip of dunnage. The feeding/connecting assembly 111 also functions to feed stock material through the machine 100, as by pulling the stock material from the stock supply assembly and through the forming assembly 110. These functions are carried out by a pair of rotating roller-like members 130, 131, 132 and 133 described in greater detail below. It will also be appreciated that the feeding/connecting assembly crumples the formed strip of stock material after which it is assembled or connected to prevent separation of the overlapped layers.

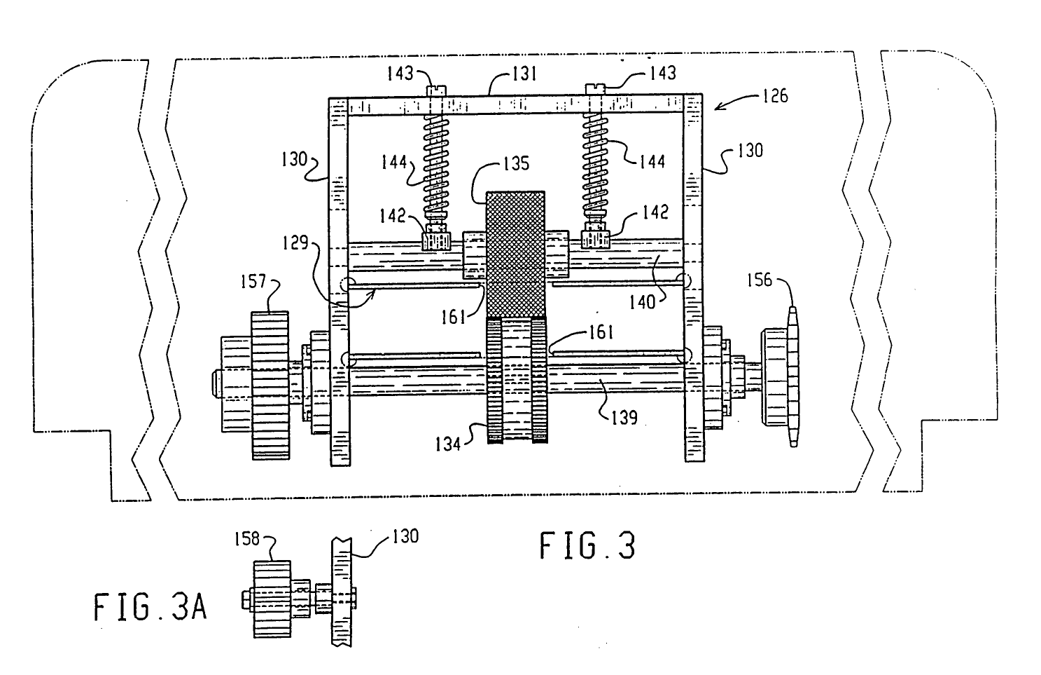

As shown in FIGS. 1, 2 and 3, a lower output roller-like member 132 is mounted to a shaft 144 rotatably driven by the feeding motor whereas the lower input roller 130 is driven by interconnection to the lower output roller 132 in gear type relationship to provide, for example, a speed ratio of about 2:1. The two other rollers 131 and 133 are idlers rotatably carried in a floating frame 135 on respective axles. The driven roller-like members 130 and 132 rotate about an axis fixed with respect to the front plate 108 whereas the two others 131 and 133 are carried by the floating frame 135 which is guided by guide slots in side plates 136 and 137 (FIG. 3) for parallel translating movement toward and away from the driven rollers 130 and 132. As is preferred, the floating frame 135, and thus the floating roller-like members 131 and 133, are resiliently biased by a pair of compression springs 138, which align both floating roller-like members 131 and 132 by way of side bars 141. The spring force may be adjusted by tightening or loosening the bolts 140 to vary the squeeze force applied by the roller-like members 130, 131, 132 and 133 to the strip of stock material passing therebetween from the forming assembly 110 to the severing assembly 112.

In operation of the machine 100, the stock supply assembly 109 supplies stock material to the forming assembly 110. The forming assembly 110 causes inward rolling, folding and shaping of the sheet-like stock material to form lateral pillow-like portions of a continuous strip of cushioning. The feeding/connecting assembly 111 advances the stock material through the machine 100 and also connects the central portion of the band to form a connected dunnage strip. As the connected dunnage strip travels downstream from the feeding/connecting assembly 111, the severing/aligning assembly 112 severs or cuts the dunnage strip into sections, or pads, of a desired length. The cut pads then travel through the post-severing constraining assembly 113.

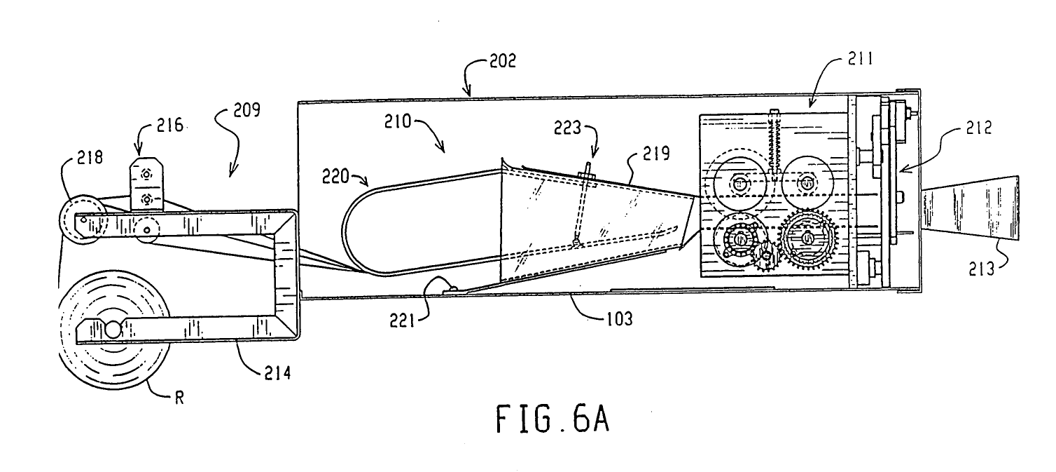

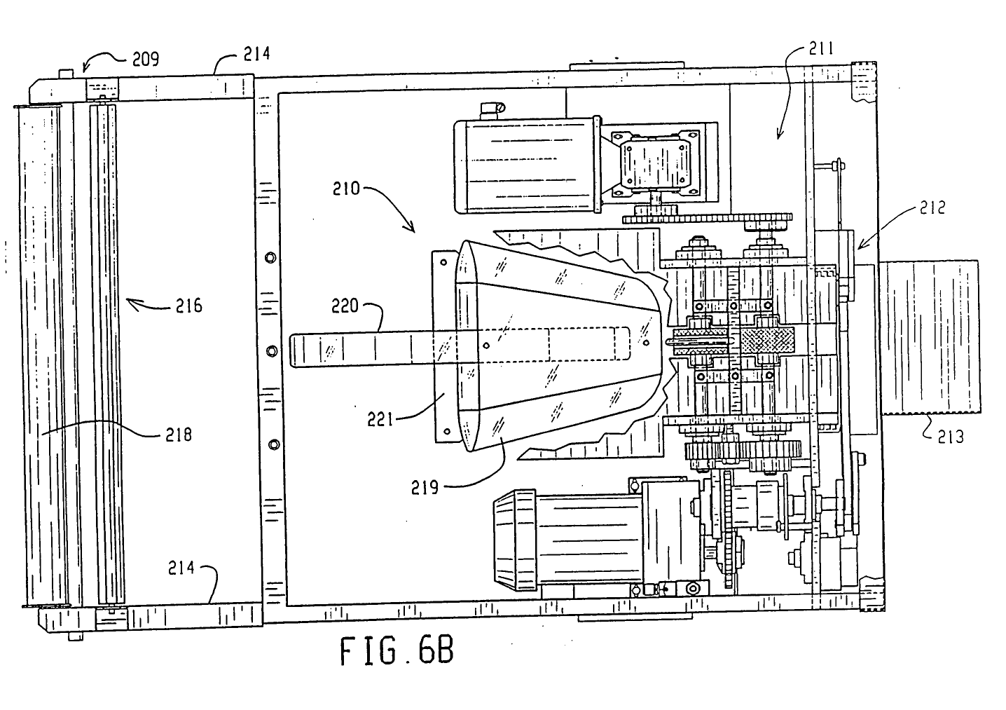

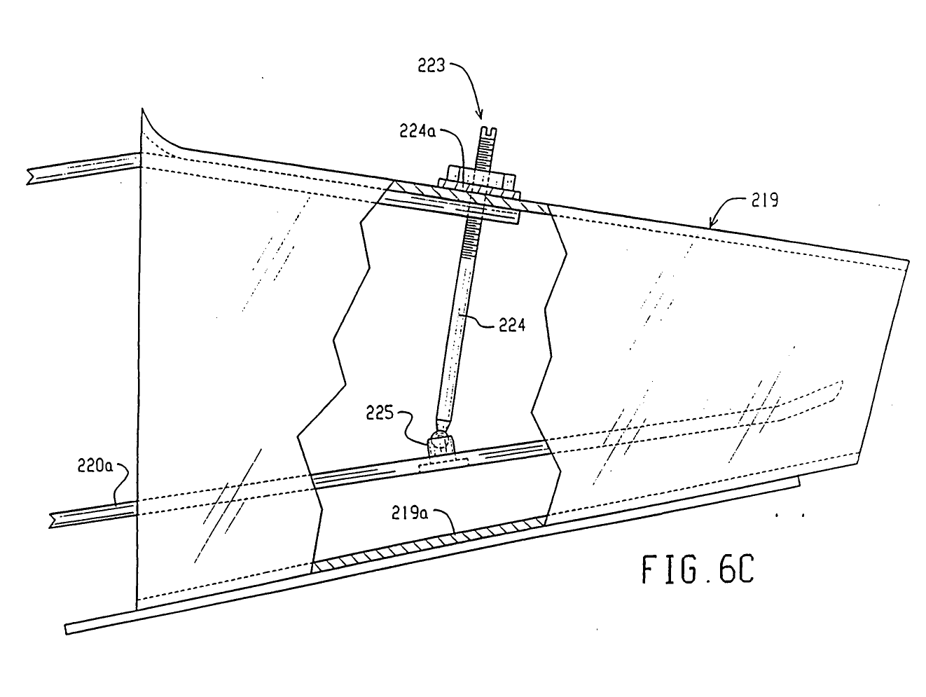

As shown in FIGS. 6A-6C, the feeding/connecting assembly 111 includes two sets of rollers, a back input set of rollers 130 and 131 and the output set of rollers 132 and 133. The input set of rollers 130 and 131 consists of a lower front roller 130 and the upper front roller 131. The output set of rollers, similarly, includes the lower back roller 132 and the upper back roller 133. The input set of rollers 130 and 131 rotate at a faster speed than the output rollers 132 and 133. The speed ratio of the two sets of rollers is dictated by the two gears 141 and 142 which provide, for example, a speed ratio of about 2:1. The lower output roller 132 is rotated by the front drive shaft 143 which is coupled to the feeding motor. The idler gear 134 enables both shafts 143 and 144 to rotate in the same direction.

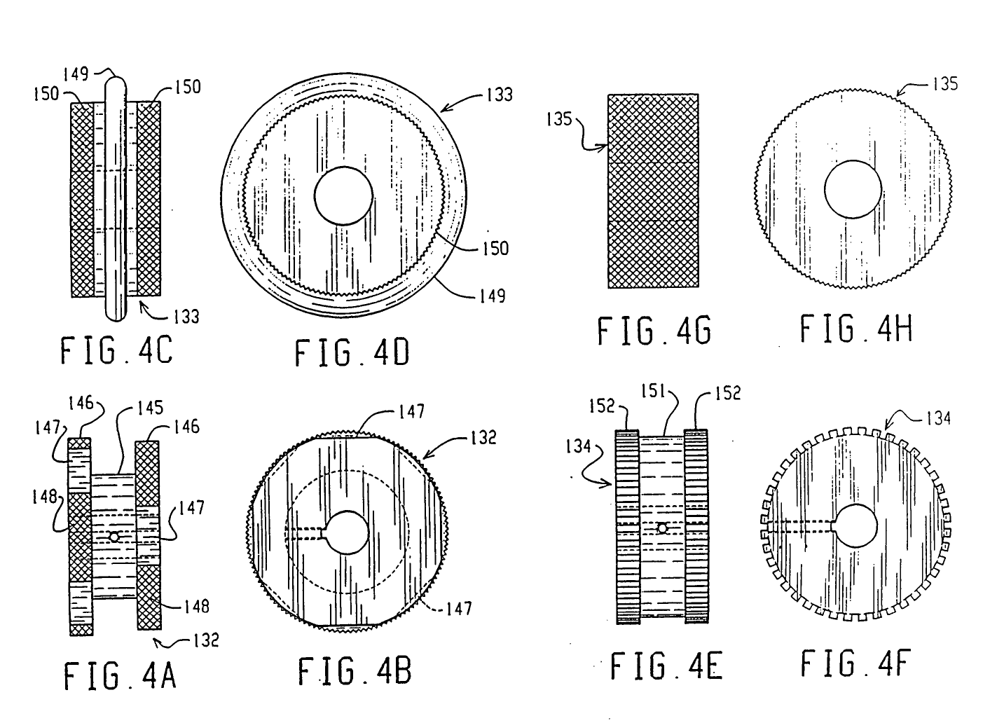

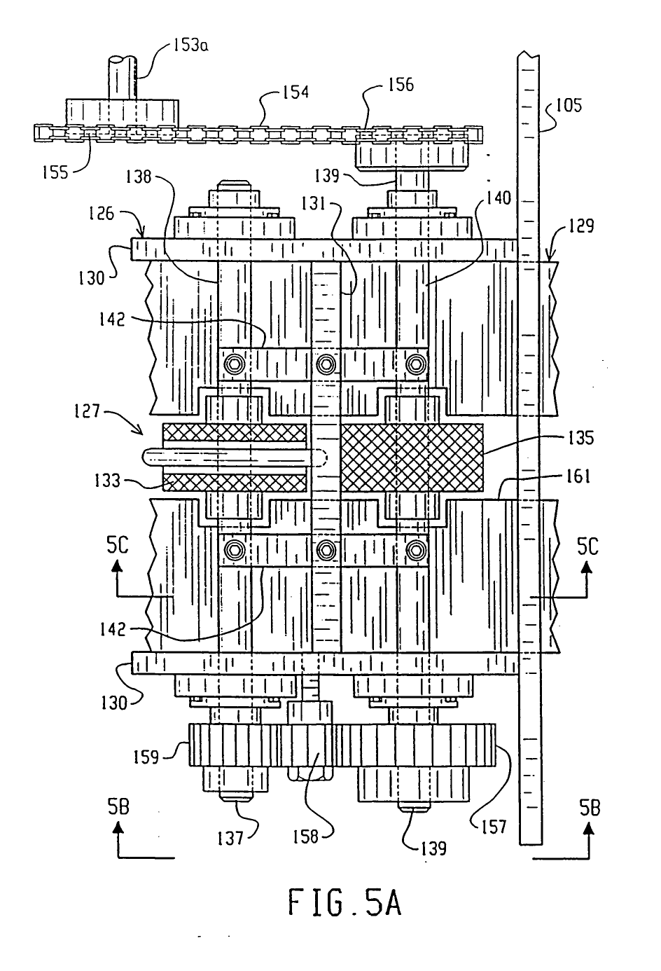

Moreover, both of the two input rollers 130 and 131 have a knurled finish on ⅓ of their outer diametric surfaces as shown in greater detail in FIGS. 4A-4D. The lower input roller is relieved in the center and the upper input roller 131 has a rounded projection at its center. The lower input roller 130 also has alternate reliefs on the knurled surfaces, and the projection of the upper roller top input roller 131 is to alternately pull the paper side to side, thus facilitating the paper to uniformly crumple (first one lateral side, then the other). The center projection on the upper input roller 130 acts as the pivot point of the paper.

Additionally, the center projection on the upper input roller 130 prevents the paper from sliding beyond a predetermined point—thereby ensuring that the paper does not slide out from the rollers.

As shown in FIGS. 4E-4H, the upper output roller 133 is completely knurled and the lower output roller 132 is relieved in the center and has transverse slots alternating with transverse ribs or teeth at its outer sections. The purpose of this set of rollers 132 and 133 is to supply enough back pressure to allow the pad to crumple between the input and output rollers, and allow the thicker pad to exit at a slower rate than the pad enters.

The top input and output rollers are spring loaded towards the bottom input and output rollers.

For further information regarding a feeding, crumpling and connecting assembly similar to that just described, reference may be had to U.S. Pat. No. 6,015,374, which is hereby incorporated herein by reference.

As a cushioned strip travels downstream from the feeding/connecting assembly 111 through the opening it passes through the severing assembly 112 which severs or cuts the strip into sections of a desired length. These cut sections then travel through the post-severing guide assembly 113, which preferably includes a converging portion 145 and a rectangular constraining tunnel portion 146. The cushioned strip then emerges from the rectangular tunnel portion 146 where an operator may remove the cushioned strip from the machine 100. For further details of a severing assembly, reference may be had, for example, to U.S. Pat. No. 5,569,146.

In accordance with one aspect of the invention, portions of the outer diametric surfaces of the feeding/connecting rollers 130, 131, 132, and 133 shown in FIG. 1 could be manufactured with rubber (neoprene or urethane) rollers thereby reducing the cost and complexity of the rollers and still providing a high level of friction/back-pressure.

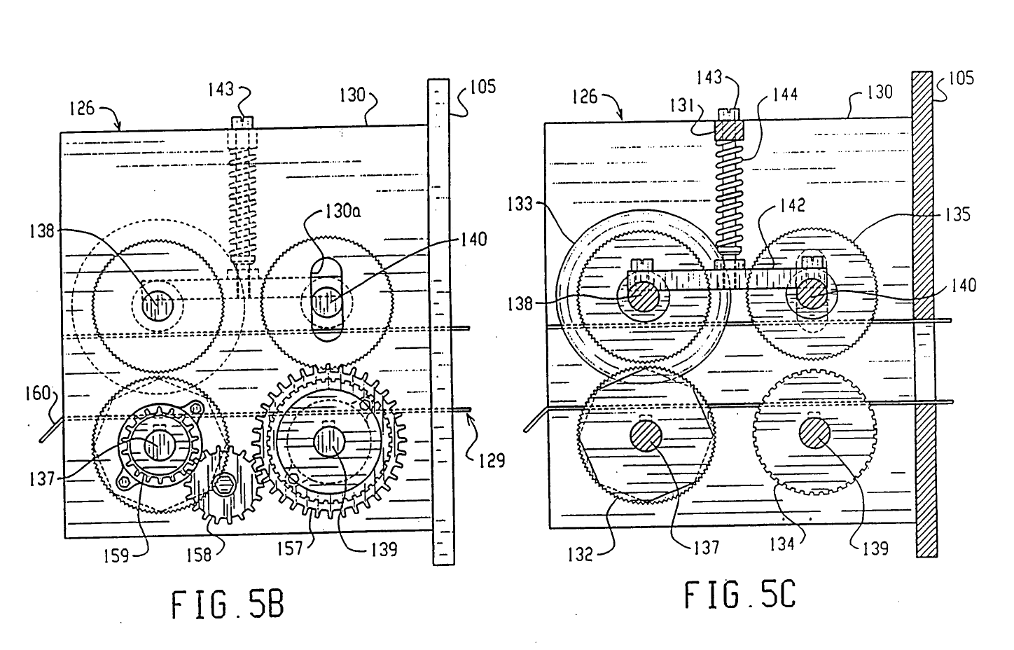

In accordance with another aspect of the invention, a pad with unique characteristics is obtained by employing a different forming assembly in place of the illustrated forming assembly 110, as shown in FIGS. 5A and 5B. The forming assembly, indicated at 200, comprises a converging chute 202 and a former 203. The chute and former are essentially the as, and thus function similarly, to the like elements shown in U.S. patent application Ser. No. 08/386,355, which is now abandoned, survived by a continuation, U.S. Pat. No. 6,135,939, which is hereby incorporated herein by reference in its entirety.

According to yet another aspect of the invention, the speed difference between the input rollers 130 and 131, and the output rollers 132 and 133 can be variably adjusted. By varying the speed difference, the character of the pad can ve varied (such as density, compactness, cushioning ability, etc.). As the speed differential is increased, a stiffer, more dense pad is produced. This type of pad could be used for packaging heavier objects. As the speed differential is reduced, the pad would become less dense, and possibly more pad would be yielded from the roll of paper. This less dense pad could be used with lighter objects.

The aforementioned variable speed relationship may be accomplished in a variety of ways, for example:

(1) Quick change gear sets could be employed to produce different types of pads for different packaging requirements. The gearing would be at set interval values and would require the operator to install the different sets.

(2) Two motors could be used, one to drive the input shaft and the other to drive the output shaft. Either drive motor could have a variable speed which would adjust the ratio between the shafts.

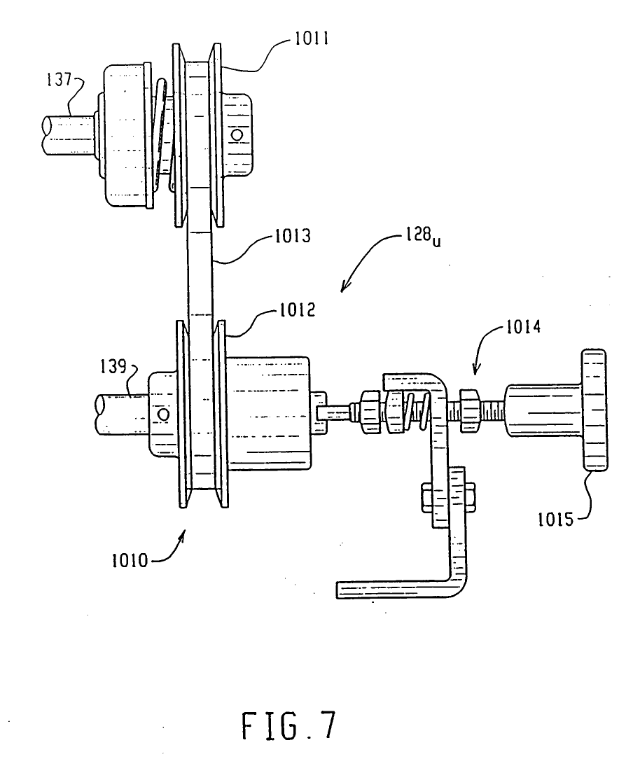

(3) A variable pitch pulley system could be used directly between the two shafts 143 and 144 (as shown in FIG. 7). This would replace the current gearing. This system would also permit an operator to adjust the ratio between the shafts. More particularly, the variable pitch pulley system includes, as is conventional, a V-belt trained over an SL-sheave on shaft 144 and an MC-sheave on shaft 143. The MC-sheave is adjusted by rotating a control knob 148 or other suitable means. The control knob 148 should be located at an accessible location preferably outside the housing for permitting easy adjustment of the variable pitch pulley system, thereby to effect a desired change in the density (or other characteristic) of the cushioning strip.

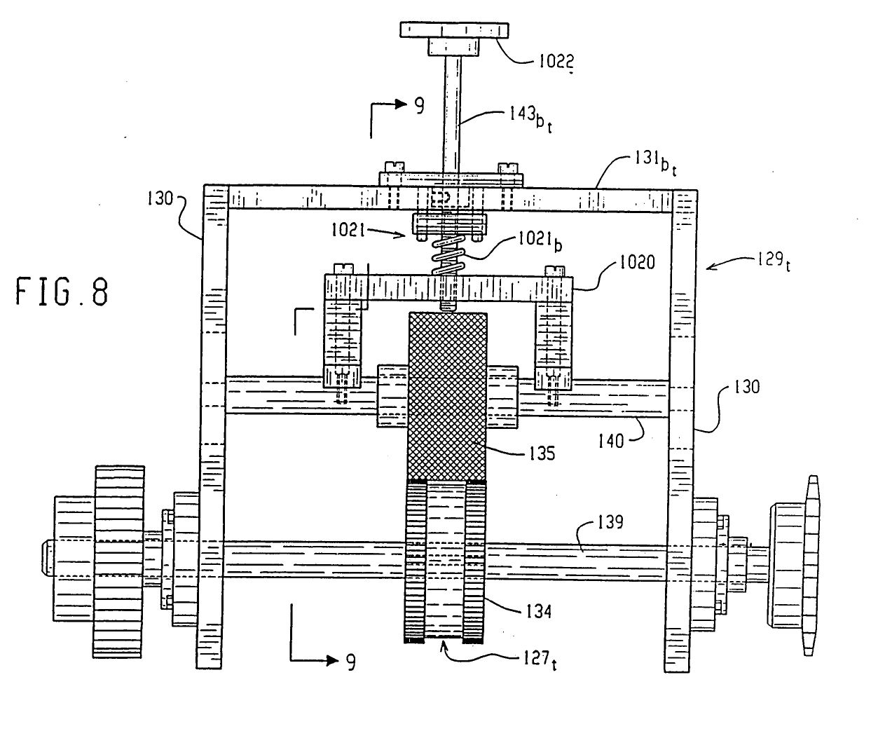

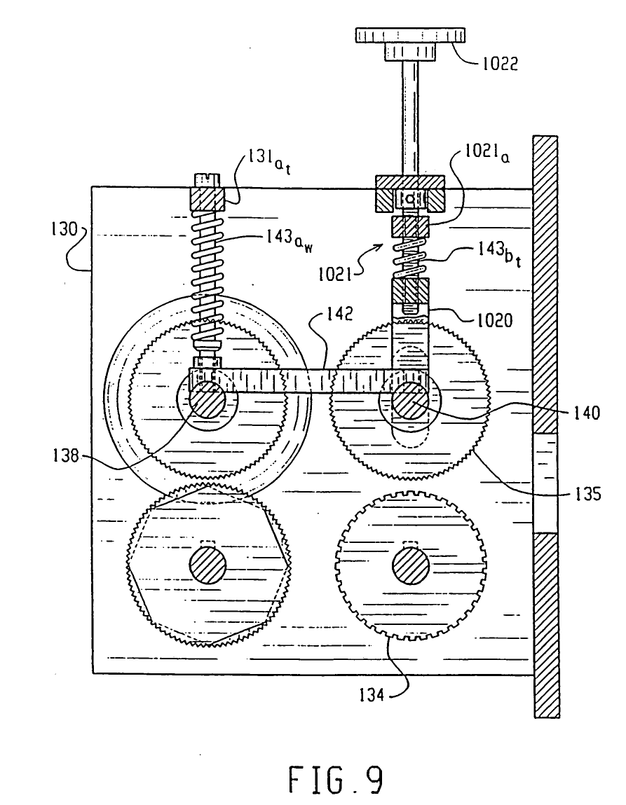

In accordance with another aspect of the invention, a modified feeding/connecting assembly may employ an operator adjustable pinch pressure control as shown in FIGS. 8 and 9, wherein primed reference numerals are used to designate elements corresponding to those designated above by the same but unprimed reference numeral. Adjustment of the pinch pressure applied by the output rollers allows an operator to adjust some of the characteristics of the pad. If the pinch pressure is increased, a stiffer, more dense pad will be produced. Such a pad could be used for packaging heavier objects. As the tension is reduced, the would be become less dense, and possibly more pad would be yielded from the paper roll. This less dense pad could be used to package lighter objects.

FIGS. 8 and 9 show a layout of a modified feeding/connecting unit 111 with independent tension springs 149 and 150 for the input and output shafts 143 and 142. The output shaft 142 has an external knob 148 for operator tension adjustment. The tension on the output shaft 142 will effect the type of pad produced. As the tension on the output shaft 142 is increased, it will become more difficult for the pad to exit—causing the paper to crumple more and produce a more dense pad.

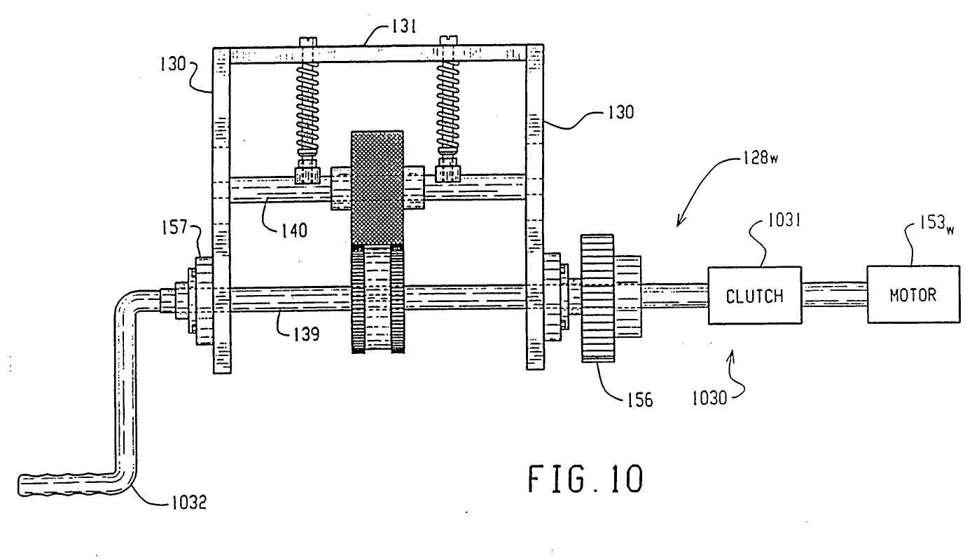

According to still yet another aspect of the invention, as shown in FIG. 10, a feeding/crumpler design 111 could be modified by adding a reverse function. Such a function could be a very useful means to clear paper jams. As seen in FIG. 10, a clutch 151 and a manual hand crank 152 could be added to a crumpling machine 100.

The purpose of the clutch 151 is to provide a means for disconnecting the feeding motor 153 from the drive shaft 154—thus allowing for more easier cranking. This clutch 151 can be electrically or mechanically applied. In the electrically applied case, the drive motor 153 is normally disengaged from the drive shaft 154. Only when the motor 153 is running is an electrical signal applied that activates the clutch 151. In the mechanically applied case, an operator would disengage the clutch 151 before using the hand crank 152.

The hand crank 152 can be permanently fixed to the machine 100 as shown, or can be “folded away,” or even removed from the machine 100 during normal operation.

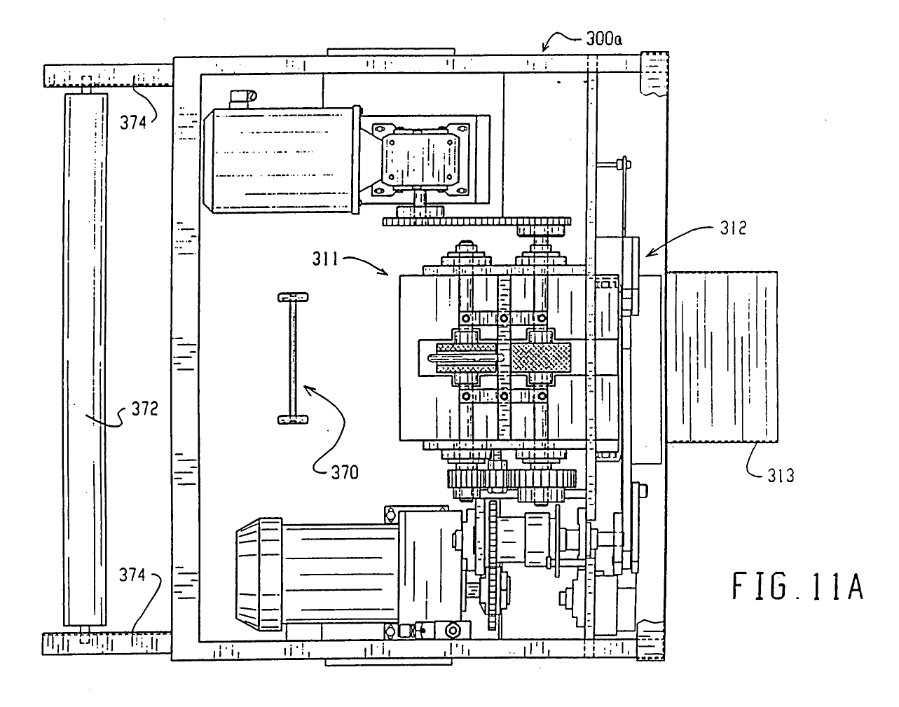

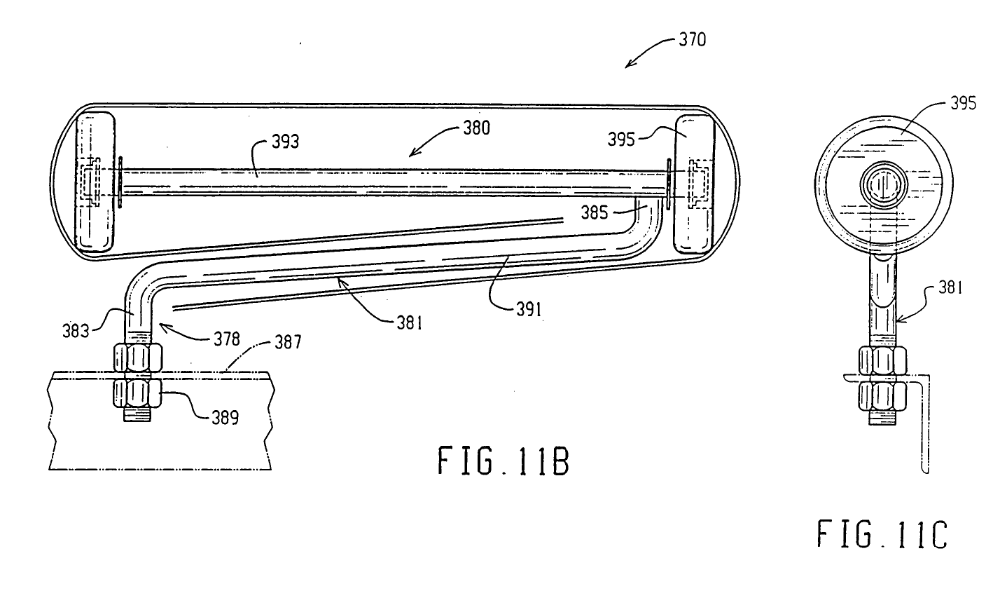

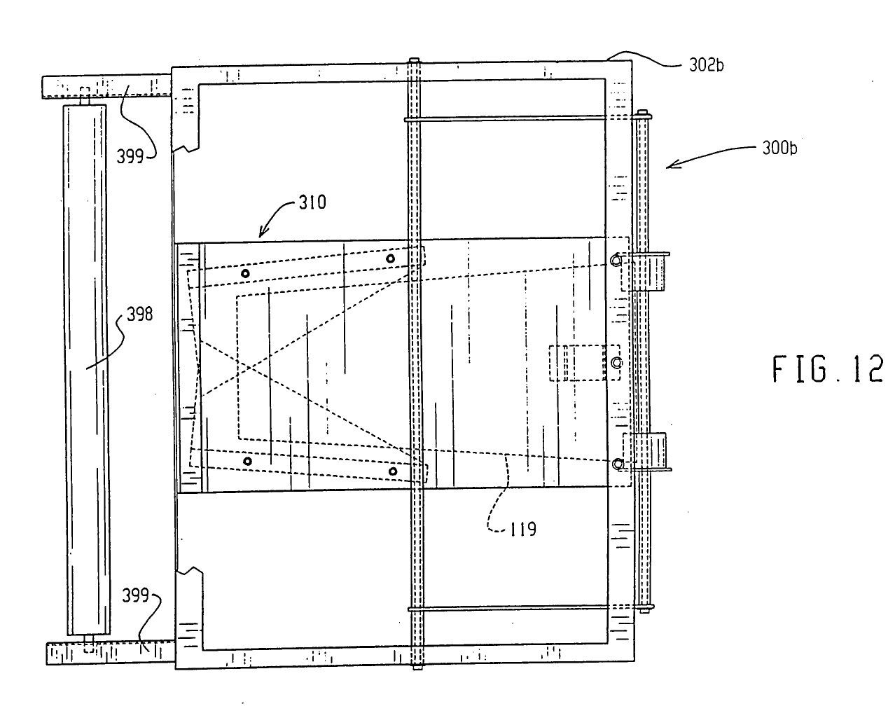

Referring now to FIGS. 11-16, several packaging systems according the invention are illustrated. The packaging systems are characterized by the use of a modular converting unit 171 shown in FIGS. 11A-11C and a modular forming unit 172 shown in FIG. 12. The converting and forming units can be located remote from one another as may be desired to provide flexibility in developing a packaging system for different application. The units will typically be employed in combination with a packaging table 175 to form a packaging system.

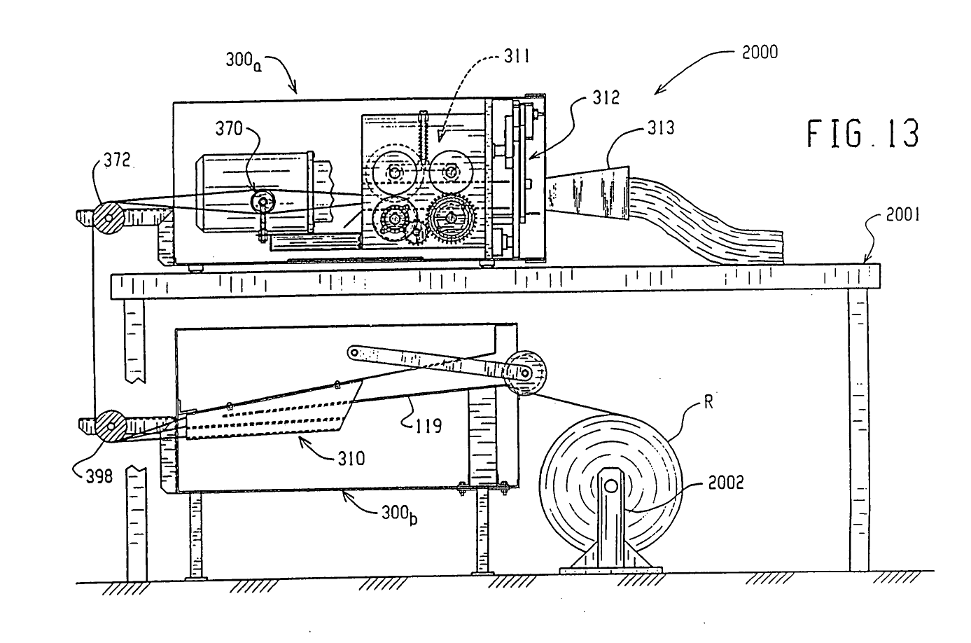

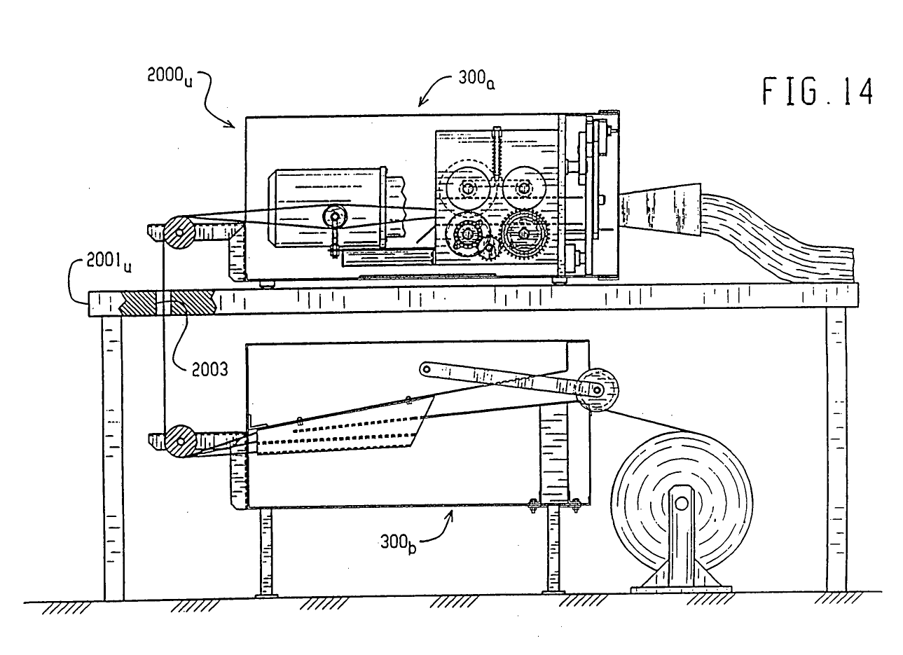

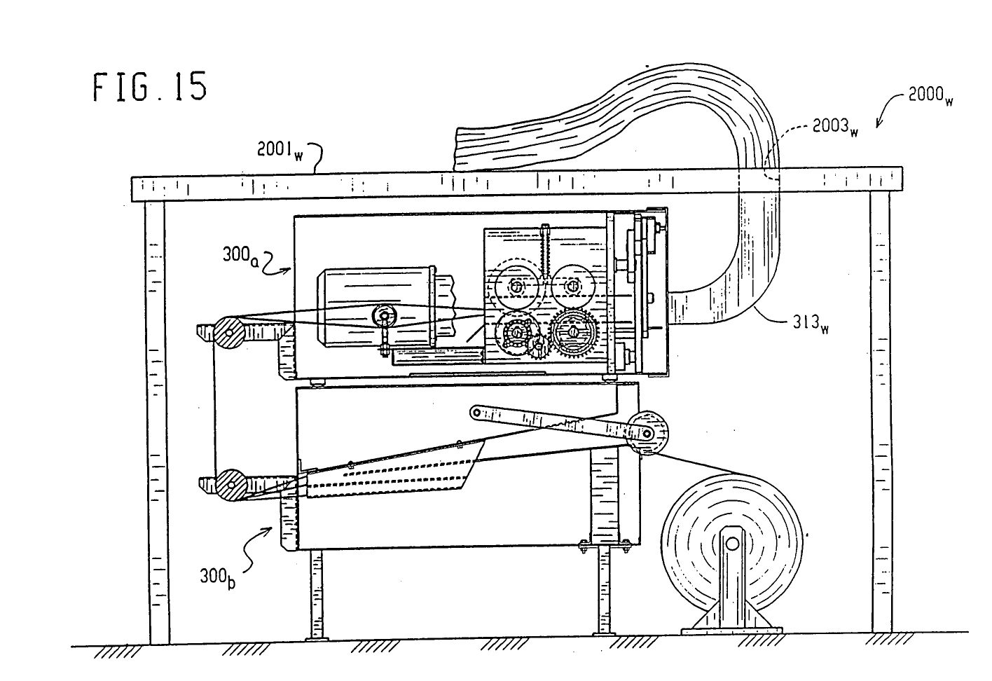

The converting unit 171 is for the most part identical to the above described conversion machine 100 (FIGS. 1 and 2) except for the elimination of the forming assembly 110 and the stock supply assembly 109, which permits a reduction in the length of the unit, and the incorporation of an expanding device 173 (shown in FIGS. 11A-11C and 13). Accordingly, like components are identified by the same reference numerals used above in the description of the machine 100 (FIGS. 1 and 2).

As seen in FIG. 11A, the converting unit 171 includes a housing 174 similar to that described in FIGS. 1 and 2. Accordingly, the housing 174 forms an enclosure for internal components of the converting unit 171. Like machine 100, the converting unit includes a feeding/connecting assembly 111, a gear drive motor 111a, a cutter motor 112a, a post-severing guide including tunnel portion 146 and other similar components which work in the manner described above. However, the converting unit 171 further includes a constant entry roll 176 and an expanding device 173. The expanding device 173 is located downstream of the constant entry roll 176 and upstream of the feeding/connecting assembly 111. The constant entry roll 176 is mounted for rotation about its axis between a pair of brackets 177 projecting from the upstream end of the housing 174.

Referring now to FIGS. 11B and 11C, details of the expanding device 173 are shown. The expanding device 173 includes a mounting member 178 to which a separating member 180 is joined. The mounting member 178 includes a transverse support or mounting arm 181 having an outwardly turned end portion 183 and an oppositely turned end portion 185 to which the separating member 180 is attached. The outer end portion 183 is mounted to the converting unit's housing 174 by a bracket 187 and suitable fastening elements 189. The mounting member 178 may be formed from bar or tube stock, and the cantilevered central portion 191 thereof may be sloped relative to a transverse center plane of the path of the stock material through the converting unit 171.

The separating member 180 includes a transverse support 193 and fold expansion elements 195 at opposite ends of the transverse support 193 that are relatively thicker than the transverse support 193, with respect to the narrow dimension of the stock material. In the illustrated expanding device, the mounting member 178 is formed by a rod or tube, and the fold expansion elements are formed by rollers supported for rotation on the transverse support at opposite ends thereof. The transverse support 193 is attached near one end thereof to the adjacent end portion 185 of mounting member 181 for support in cantilevered fashion.

The expanding device 173 is designed for use with flat-folded stock material which is formed by the forming unit 172 (FIG. 12). During the conversion process, the layers of the stock material (formed by the edge and central portions of the ply or plies) travel through the expanding device 173. More particularly, the central portion 196 of the folded stock material travels over the sides of the rollers 197 opposite the mounting arm 181, while the inner edge 198 portion of the stock material travels in the narrow V-shape or U-shape slot formed between the transverse support 193 and the mounting arm 181 and the other or outer edge portion of the 199 travels over the side of the mounting arm 181 furthest the separating member 180. As a result, the edge portions are separated from one another and from the central portion, thereby introducing loft into the then expanded material which now takes on a three dimensional shape as it enters the guide chute 198 of the feeding/connecting device 111.

Thus, the expanding device 173 is operative to separate adjacent layers of the flat folded stock material from one another as it passes therethrough to form an expanded strip of stock material. For further details regarding an expanding device similar to that just described, reference may be had to U.S. Pat. No. 6,015,374, which is hereby incorporated herein by reference in its entirety.

Referring now to FIG. 12, the forming unit 172 includes a housing 201 which forms an enclosure for interior components of the forming unit. The forming unit 172 includes a forming assembly 110 like that above described in connection with the embodiment of FIGS. 1 and 2. The forming assembly functions to fold lateral edge portions of the stock material over a center portion, and the folded stock material passes to a constant exit roll 205 where the folded over portions are brought together to form a flat folded stock material. The constant entry roll 205 is rotatably mounted between a pair of brackets 207 projecting from the upstream end of the housing 201. The forming unit 172 is shown supported by a plurality of legs; however, the forming unit 172 may be positioned directly on the floor or supported by other suitable means.

In FIG. 13, the converting unit 171 and forming unit 172 are shown arranged with the packaging table 175 to form a packaging system 210. The table 175 includes a horizontal work platform or table top 181 and support means such as a plurality of legs 183 which support the table top 181. In the packaging system 210, the converting unit is supported atop the table top 181, and the forming unit 172 is shown positioned below the table top. The converting unit 171 may be equipped with plastic feet 178, or other anti-skid devices, to prevent shifting of the converting unit 171 along the top of the table 175 or other support surface upon which the converting unit 171 rests. The legs 183 (e.g., support means) include or define therebetween an opening 185 through which the downstream end of the forming unit 172 extends outwardly of an edge of the table 175 for supplying the flat folded stock material to the converting unit 171. As is explained below in greater detail, this arrangement of the converting unit 171, the forming unit 172 and the table 175 affords for convenient location of the stock material, easy threading of the stock material, and optimizes the use of valuable floor space by the machine.

A stock supply assembly 212 supplies the paper product to the forming unit 172. In the illustrated embodiment, the stock supply assembly includes a floor supported stand 213 which supports a roll of paper (or other stock material) 213 mounted on a support. Of course a variety of conventional stock supply assemblies could be utilized for the purpose of supplying paper to the forming unit 172.

The paper travels from the supply assembly 212 to the forming unit 172 where it is folded to form flat folded stock material. The flat folded stock material exits from the forming unit 172 at the exit roller 205 and passes to the entry roller 176 of the converting unit 171. The stock material then passes to the expanding unit 173 where it is expanded as described above and then fed into the feeding/connecting assembly 111 where it undergoes the process described above to form a three-dimensional strip of cushioning.

FIGS. 14-16 illustrate other packaging systems including other arrangements of the converting unit 171, forming unit 172 and table 175. FIG. 14 shows a packaging system 216 essentially the same as the packaging system 210 shown in FIG. 13 except that the stock material passes from the constant exit roll 205 to the constant entry roll 176 via a slot 235 in the table top 181. This arrangement further reduces the amount of floor space occupied by the converting unit 171, forming unit 172 and table 175 arrangement since the forming unit does not extend beyond the edge of the table as in FIG. 13.

FIG. 15 shows a packaging system 237 wherein the converting unit 171 is situated beneath the table top 181 and on top of the forming unit 172. This arrangement provides for increased work space on the table surface 187. Additionally, the 3-dimensional dunnage product is supplied by a chute 238 to an opening 250 in the table top.

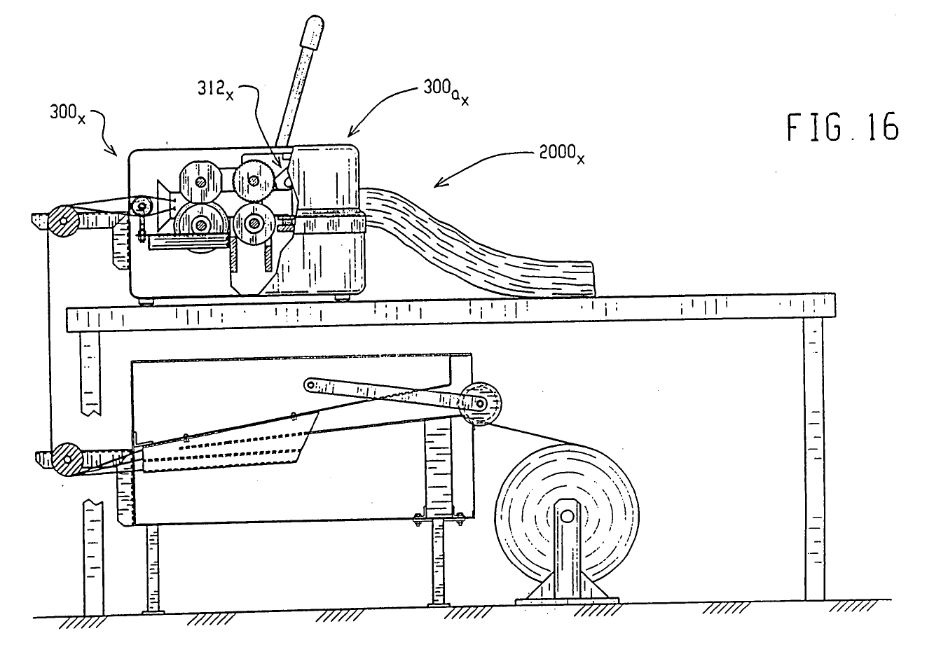

FIG. 16 shows a packaging system 253 having an arrangement similar to FIG. 13 except that a different form of converting unit 275 is shown. The converting unit 275 does not have a motor-powered severing assembly as does the converting unit 171. Rather, the converting unit 275 employs a hand operated handle 277 which is movable to actuate a severing assembly for cutting sections of the strip of cushioning. Additionally, the housing 279 is in the form of a two part casing. The other components, such as the expanding device 281 and feeding/connecting assembly 283, operate in essentially the same manner as described above. For further details of the converting unit 275, reference may be had to U.S. Pat. No. 6,015,374.

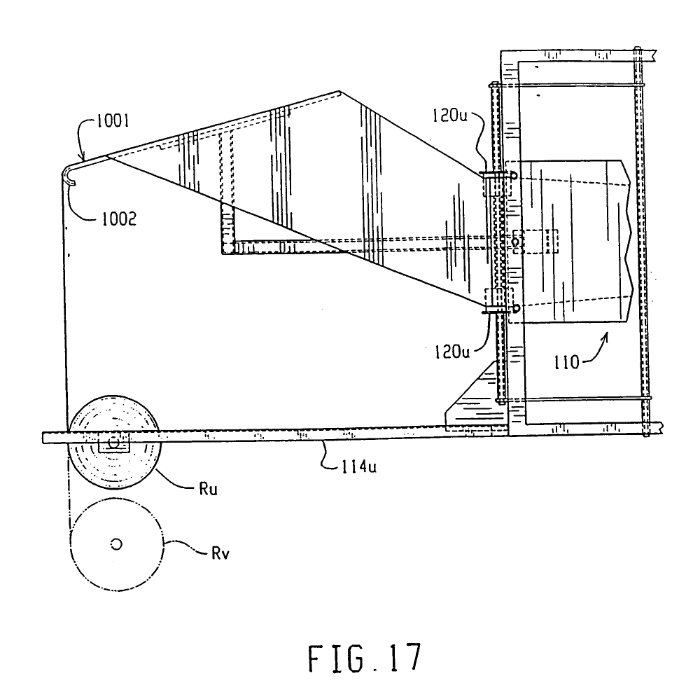

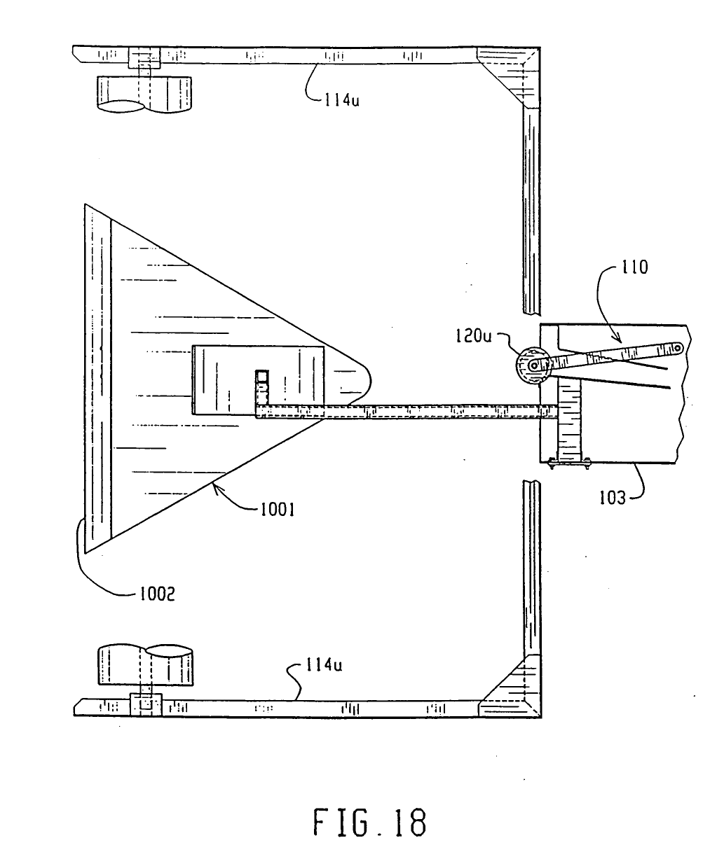

FIGS. 17 and 18 illustrate another embodiment of the present invention wherein the supply roll 300 is mounted in an upright orientation on a pair of brackets 301 such that the paper is fed to a turner member 303 in a substantially perpendicular manner. Feeding the paper at a substantially perpendicular angle provides adequate tension on the paper to prevent wrinkling or creasing of the paper yet at the same time not providing so much tension on the paper to cause tearing.

The supply roll 300 is rotatably supported on a spindle 305 which is supported by brackets 301 at cradles 303. The supply rod 305 is sized to extend relatively loosely through the hollow core tube of the stock supply roll 300, and the supply rod 305 is sized to be approximately the distance between the two brackets 301 of the turner member 307. The paper unwinds from the supply roll 300 and enters the forming assembly 309 after passing over the turner member 307. As the paper passes over the turner member 307 which includes a turner plate 311, the sides of the paper fold over the turner member wherein the lateral edge portions of the paper overhang the sides of the turner plate 311. Folder rollers 313 and 315 mounted on an axle 317 further encourage the paper to fold down on either side of the turner plate 311. The folder rollers 313 and 315 also function in essentially the same manner as described above with respect to rollers 123 and 124 in FIGS. 1 and 2.

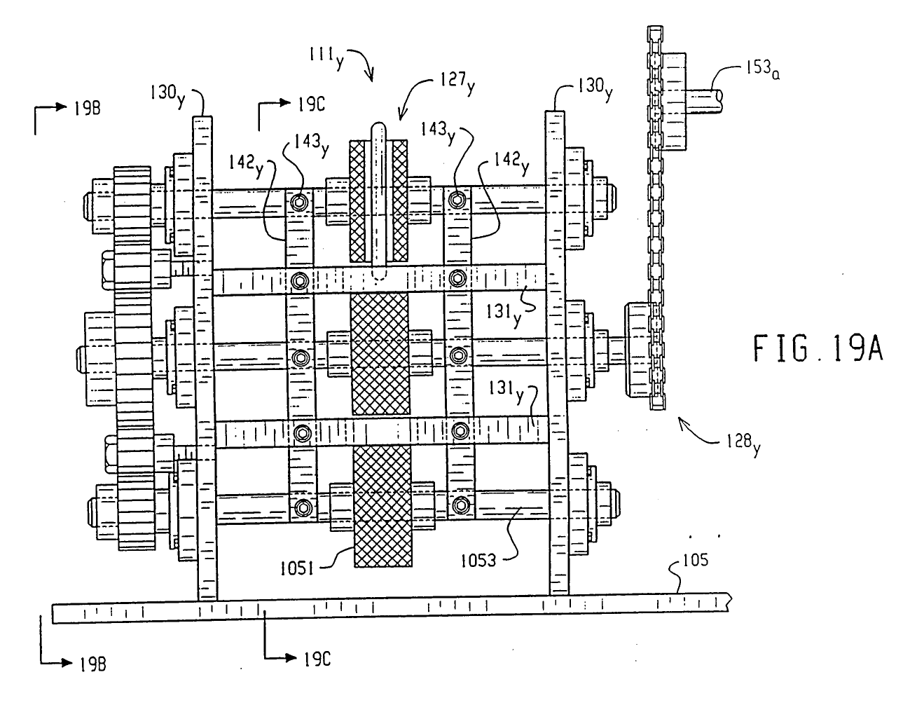

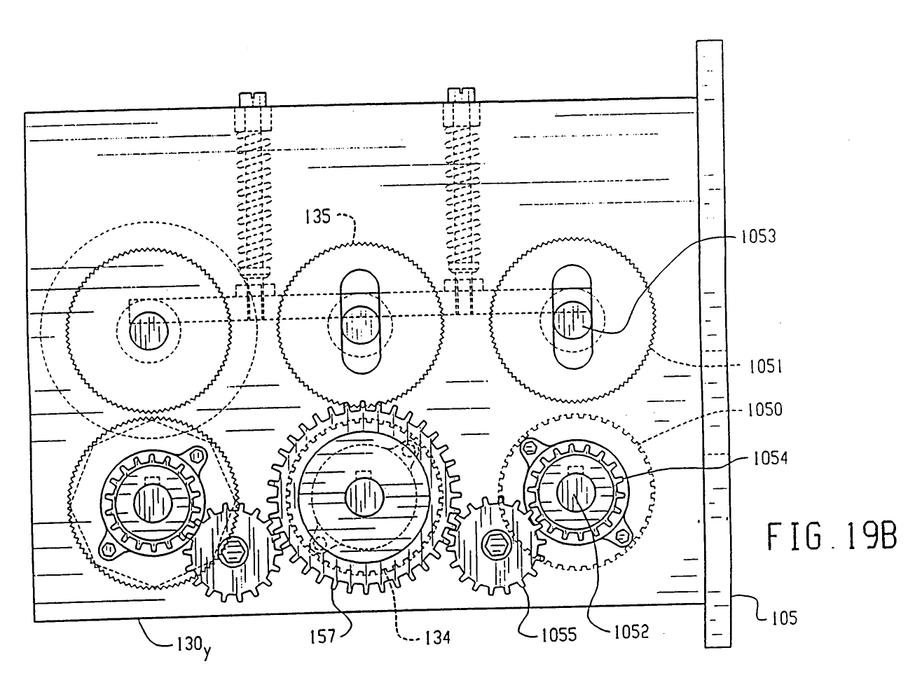

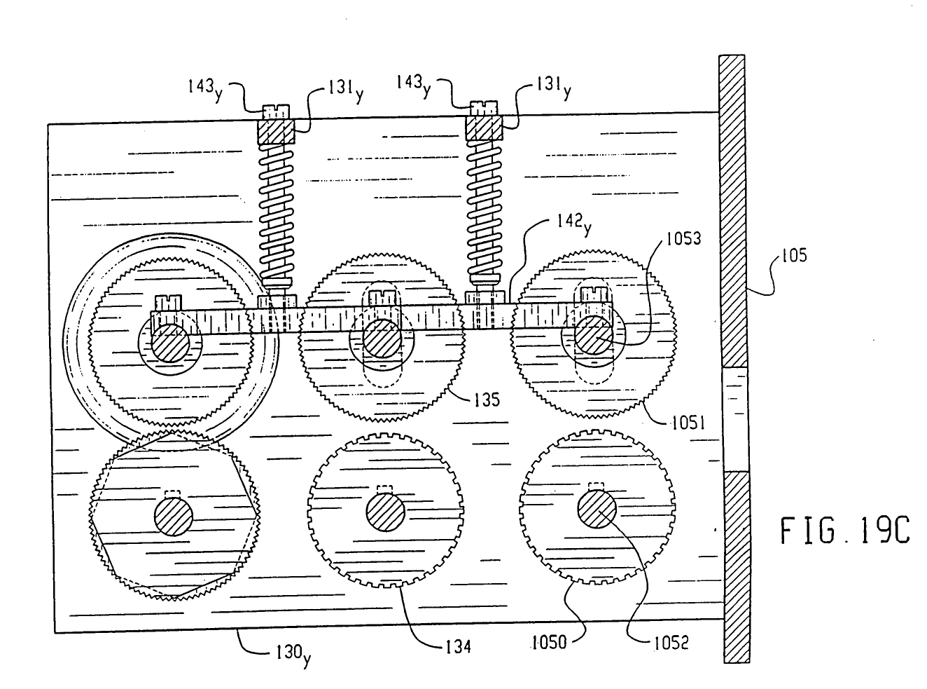

In yet another embodiment of the present invention, FIGS. 19A, 19B & 19C illustrate a modified feeding/connecting assembly 355 wherein a third set of rollers 365 and 367 are located downstream of the input and output rollers 357, 359, 361 and 363. The input and output rollers operate in essentially the same manner as the rollers 61, 63, 65 and 67 described above (FIGS. 1-4) to form a strip of cushioning. The third set or stretching rollers 365 and 367 function to stretch the strip of cushioning exiting from the output rollers 361 and 363. The roller 365 is driven at a faster rate than the crumpled paper exits the output rollers 361 and 363 which in turn effects a stretching action on the crumpled paper in the longitudinal direction. [Do we have any particulars on speed ratios?]

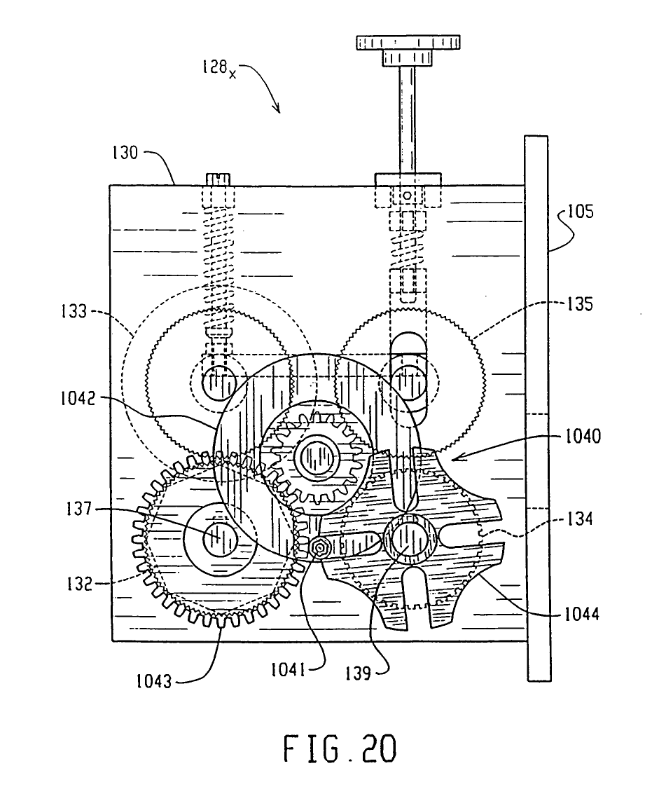

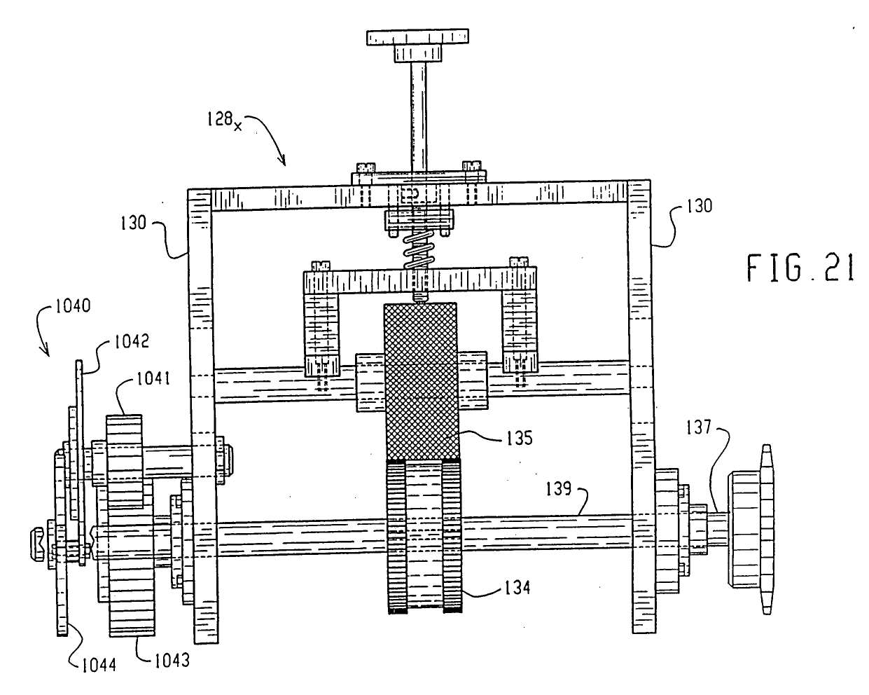

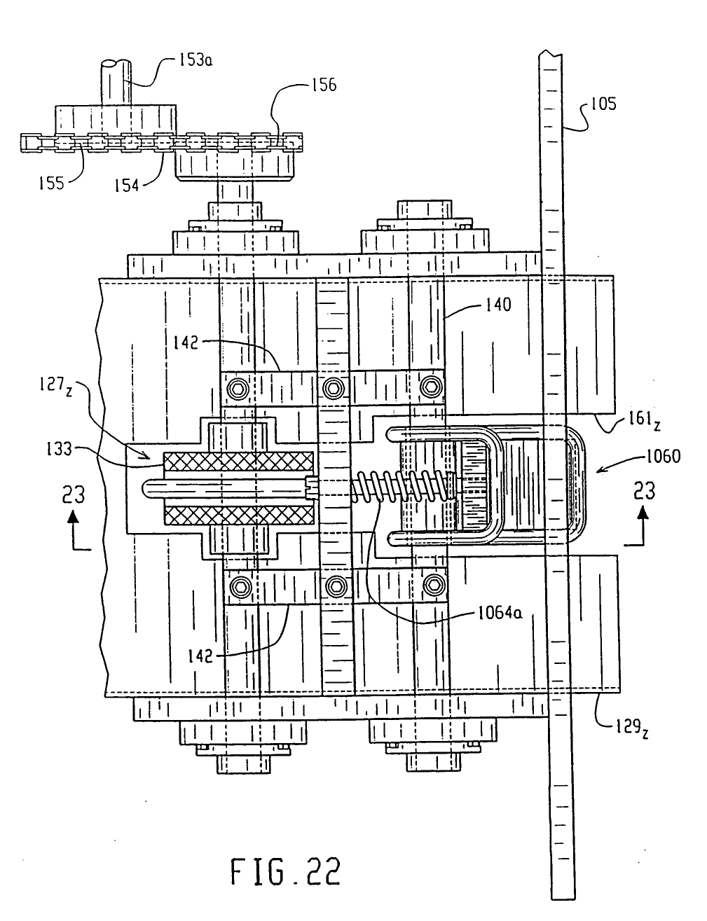

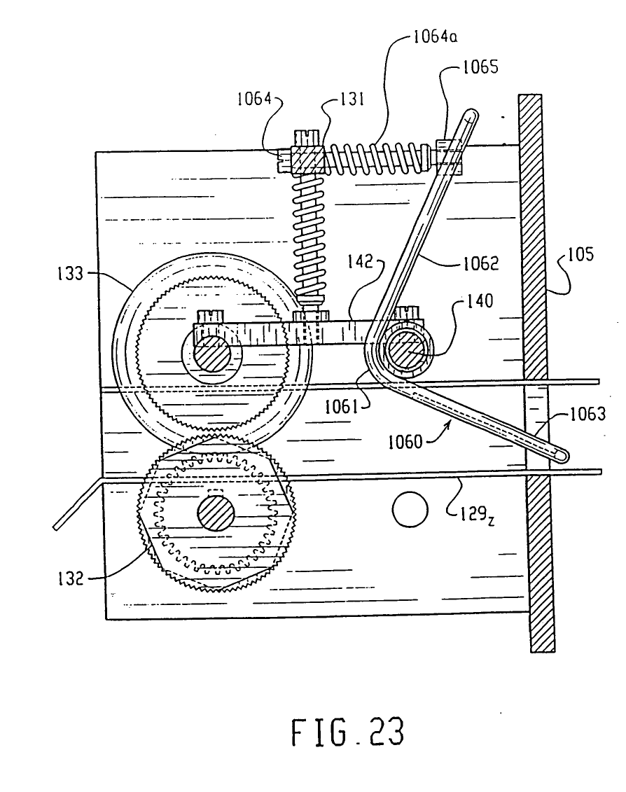

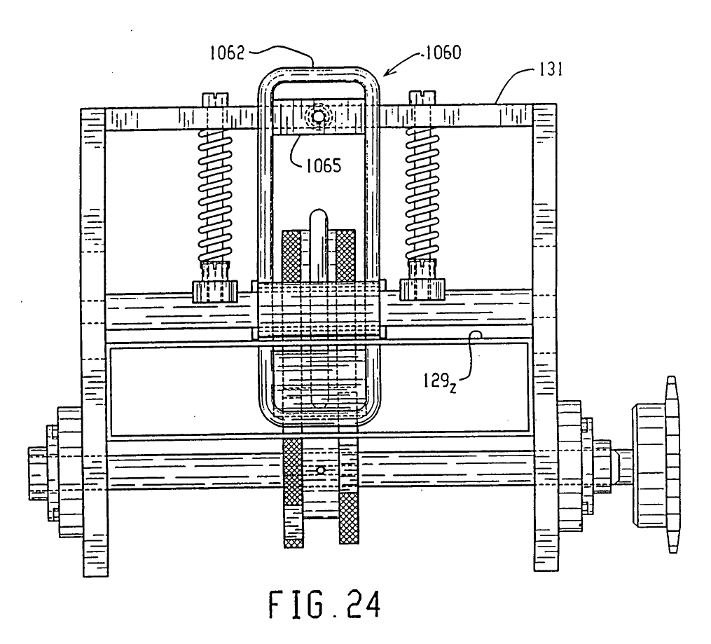

Referring now to FIGS. 20 and 21, an another form of feeding/connecting assembly 375 is illustrated. The assembly 375 includes an indexing gear mechanism 377. The assembly 375 includes input and output rollers 379, 381, 383 and 385 wherein the input rollers 379 and 381 are driven continuously while the output rollers 383 and 385 are driven intermittently. That is, the indexing mechanism 377 operates to intermittently rotate the output or downstream rollers 383 and 385 through a partial revolution (such as ¼) for every full revolution of the input or upstream rollers 379, 381. When the output gears are not rotating, the stock material is crumpled as the input roller will continue to advance the stock material towards and against the output rollers. When the output roller are rotated, the crumpled stock material exits therefrom to form the strip of cushioning. As will be appreciated the indexing pattern can be varied to vary a characteristic of the strip of cushioning.

In the illustrated embodiment, the indexing mechanism 377 includes a Geneva gear mechanism which includes a driver disk 391 with a cam follower 393 is mounted thereon. A 4-slotted disk 395 is mounted parallel to the bottom output roller 3893 so that it may engage with the cam follower 393. The driver disk 391 is indexed with the upstream bottom roller 379 in a 1:1 relationship so that for every full revolution of the upstream roller 379, the driver disk 391 will also revolve one revolution. Accordingly, as the driver disk 391 makes one revolution it will cause the 4-slotted disk 395 to rotate ¼ revolution via the cam follower 393 which in turn rotates the downstream rollers 383, 385 ¼ revolution.

Additionally, an operator adjustable tension control 401 could be added in order to adjust various characteristics of the pad. This tension control 401 operates in essentially the same manner as described above in FIG. 8.

While a particular feature of the invention may have been described above with respect to only one of the illustrated embodiments, such feature may be combined with one or more features of the other embodiments, as may be desired and advantageous for any given or particular application.

Although the invention has been shown and described with respect to certain preferred embodiments, it is obvious that equivalent alterations and modifications will occur to others skilled in the art upon the reading and understanding of this specification. The present invention includes all such equivalent alterations and modifications.

What is claimed is:

1. A conversion machine for converting a sheet stock material into a dunnage product, comprising: a feeding assembly having a first pair of rotating components and a second pair of rotating components downstream of the first pair, the feeding assembly operative to pull the stock material from a source thereof along a path and crumpling the stock material; and an apparatus for varying characteristics of the crumpled dunnage product.

2. A cushioning conversion machine for making a cushioning product by converting an essentially two-dimensional web of sheet-like stock material of at least one ply into a three-dimensional cushioning product, comprising:
a feeding/connecting assembly which advances the stock material from a source thereof along a path, crumples the stock material, and connects the crumpled stock material to produce a strip of cushioning, the feeding/connecting assembly including:
upstream and downstream components disposed along the path of the stock material, at least the upstream component being driven to advance the stock material toward the downstream component at a rate faster than the sheet-like stock material can pass from the downstream component to effect longitudinal crumpling of the stock material therebetween to form a strip of cushioning, and
a stretching component downstream of the downstream component operative to advance the strip of cushioning at a rate faster than the rate at which the stock material passes from the downstream component to effect longitudinal stretching of the strip of cushioning.

3. A conversion machine as set forth in claim 2, comprising a housing that encloses at least a portion of the feeding/fixing assembly and through which the stock material passes along the path.

4. A conversion machine as set forth in claim 2, wherein the feeding/connecting assembly includes an adjustable speed control mechanism for varying the speed at which the stretching component advances the material, whereby a characteristic of the strip of cushioning can be varied.

5. A conversion machine as set forth in claim 2, wherein the downstream feed component is driven to advance the material at a rate less than the rate at which material is advanced by the upstream component.

6. A conversion machine as set forth in claim 3, wherein the feeding/connecting assembly includes an adjustable speed control mechanism for varying the ratio of the rates at which the upstream and downstream components advance the stock material.

7. A conversion machine as set forth in claim 6, wherein the adjustable speed control mechanism includes a quick change gear set.

8. A conversion machine as set forth in claim 3, wherein the upstream and downstream components each including opposed members between which the stock material is passed and pinched by the opposed members with a pinch pressure

9. A conversion machine as set forth in claim 8, wherein at least one of the opposed members is at least partially made of an elastomeric material at a surface thereof engageable with the stock material.

10. A conversion machine as set forth in claim 7, wherein the elastomeric material is rubber.

11. A conversion machine as set forth in claim 2, wherein the downstream feeding component is driven to advance the stock material periodically, whereby periodically the longitudinally crumpled stock material will be advanced by the downstream feeding component toward a downstream end of the machine.

12. A conversion machine as set forth in claim 2, when the downstream feeding component is not being driven the stock material will be caused to crumple longitudinally between the upstream and downstream feeding components, and when driven the longitudinally crumpled stock material will be advanced by the downstream feeding component toward an exit end of the machine.

13. A conversion machine as set forth in claim 2, wherein the upstream and downstream components each include a rotating member for drivingly engaging the stock material, and the feeding/connecting assembly includes a motor coupled to the rotating member of the upstream component for continuously driving the upstream component during a cushioning formation operation, and to the rotating member of the downstream component by an indexing gear mechanism that effects intermittent rotation of the rotating member of the downstream component.

14. A conversion machine as set forth in claim 13, wherein the indexing gear mechanism includes a Geneva gear mechanism.

15. A conversion machine as set forth in claim 2, wherein the feeding/connecting assembly includes opposed guides extending between the upstream and downstream components for containing the crumpled strip therebetween.

16. A conversion machine as set forth in claim 2, comprising a forming assembly through which the sheet-like stock material is advanced to form the stock material into a three-dimensional shape, the forming assembly including a forming member and a converging chute cooperative with the forming member to cause inward turning of the edges of the stock material to form lateral pillow portions of a formed strip.

17. A conversion machine as set forth in claim 16, wherein the forming member has a U-shape with a first leg attached to a top wall of the chute and a second leg extending into the chute generally parallel with a bottom wall of the chute.

18. A method for making a cushioning product by converting an essentially two-dimensional web of sheet-like stock material of at least one ply into a three-dimensional cushioning product, including the steps of:
supplying the stock material;
using an upstream component of a feeding/connecting assembly to advance the stock material toward a downstream component of the feeding/connecting assembly at a rate faster than the sheet like stock material can pass from the downstream component to effect crumpling of the stock material therebetween to form a strip of cushioning; and
varying the ratio of the feeding speeds of the upstream and downstream feeding components, whereby a characteristic of the strip of cushioning can be varied.

19. A method as set forth in claim 18, wherein the varying step includes adjusting a variable speed drive device for one of the upstream and downstream components.

20. A method as set forth in claim 18, wherein the varying step includes replacing a quick change gear set with a different gear set.
